(19) United States
(12) Patent Application Publication
(10) Pub. No.: US 2006/0148489 A1
(43) Pub. Date: Jul. 6, 2006

(54) Position communication method and apparatus

(75) Inventor: Michael Leslie Norman, Lobethal (AU)

Correspondence Address: OSHA LIANG L.L.P., 1221 MCKINNEY STREET, SUITE 2800, HOUSTON, TX, 77010, US

(73) Assignee: Michael Leslie Norman, Lobethal (AU)

(21) Appl. No.: 10/540,115

(22) PCT Filed: Dec. 19, 2003
(86) PCT No.: PCT/AU03/01692

§ 371 Date: Dec. 30, 2005

(30) Foreign Application Priority Data
Dec. 20, 2002 (AU) 2002953451

(51) Int. Cl. H04Q 7/20

(52) U.S. Cl. 455/456.1

(57) ABSTRACT

A wireless communication apparatus and network including voice transmission means characterized in that there is included a location position determination means adapted to output data which uniquely characterises a geographic location of the apparatus, and means adapted upon an initiation of a close of a voice transmission from said apparatus to effect transmission of data arising from the position determination means whereby such data can effect an identification of the said location which can be interpreted by further receiving means. There is included a wireless network base station adapted to receive, during termination of a signal being received from a mobile station, data identifying the location of the mobile station.

### TECHNICAL FIELD

This invention relates to a method of effecting communication of position data and it also relates to apparatus which assists in effecting position data communication.

The invention has particular application to communication networks where there are mobile units where the location of such a unit is usefully communicated, from time to time, to others.

### BACKGROUND ART

The type of application might be where there is, for instance, a fire truck with a radio transmitter and receiver which wants to transmit to others, for instance, a base station, its position from time to time for a number of very obvious reasons.

These might be that a base station, knowing where the truck is, can give urgent warning if the truck is in a potentially dangerous area or even if such a truck is not being threatened, its position can be relevant to assessing where units should be placed or should be shifted, from time to time, to other locations by a person, for instance, directing resources in relation to a fire.

While a fire truck problem is illustrative, it will be clear that there are a number of situations where the location information needs to be established on a regular and reliable basis.

The current method used is for a global positioning system to be used and an operator in the mobile unit will read the output from the GPS and then transmit this by voice through wireless transmission.

There are three obvious problems with this system as it currently exists.

The first is that the time taken for a person to read and verbally transmit that data through the transmission system is substantial. Typically with even efficient operators, this may take as long as 15 to 20 seconds or more.

A second serious problem Is that it is not certain that such data will be correctly identified through a voice communication by a receiving station.

It is possible, of course, to go both slowly and repeat the data several times but this then significantly extends the time to establish this transfer of information.

Thirdly, the information that has been transmitted has to be translated and then used to identify the position, perhaps visually on a strategy board or otherwise which again take significant time at, for instance, a base station.

It is to be remembered that the time taken is also excluding others from access to that channel at that time and this therefore can cause quite significant crowding of a channel in times of significant activity.

An object of this invention is to propose an arrangement and a method which will provide for a better system that, at the least, reduces the above problems.

### DISCLOSURE OF THE INVENTION

In one form of this invention, there is proposed a wireless communication apparatus including voice transmission means characterized in that there is included a location position determination means adapted to output data which uniquely characterises a geographic location of the apparatus, and means adapted upon an initiation of a close of a voice transmission from said apparatus to effect transmission of data arising from the position determination means whereby such data can effect an identification of the said location which can be interpreted by further receiving means.

In preference, there are means to receive and store said output data from the position determination means in digital form.

In preference, there are means to detect an initiation of the close of a transmission and to then effect a maintenance of any transmission status either until the output data is transmitted or for a sufficient time to allow for the output data to be transmitted.

In preference, the initiation of the close of a transmission is by release of a transmit button.

The data transmitted may be received either by a dedicated base station, or reception facilities may be incorporated into the transmitting apparatus.

In preference, the apparatus includes means to receive data indicating the geographic location of a further such apparatus.

What has been discovered is that the transmission of this location data can be made to occur in a way that firstly does not depend upon an operator to attempt to verbally transmit the data but that uses the fact that, if a transmission from a network is actually occurring, then upon an initiation of a signal that such transmission is to cease, continue the transmission for a sufficient period so that GPS or other equivalent location data can then be automatically transmitted to a receiving station before the transmission actually ceases.

Conventionally, there is some form of signal whereby the decision to stop transmission is effected, for instance, by release of a transmit button.

Because the transmission is occurring at that time, it is then a relatively assured process to keep such transmission on going for a period sufficient to effect the transmission and reception of data.

Usefully, there are means at the receiving station that recognize the receipt of the data and include means to firstly identify the identity of the source of such data, the location information and the time of transmission so that this then can be transferred either electronically onto a display unit or, of course, it can then be taken manually and transferred to a position board.

In preference there are means to recognise the receipt of geographic location data and means to identify the identity of the source of such data, means to interpret the data to provide location information and the time of transmission and means to transfer such information to a display means.

The display means may be an electronic means to which data is transferred digitally, or there may be a manual means to which data is transferred manually, such as a position board.

In preference, the data transmission is through frequency shift keying.

In a further form of the invention, it may be said to reside in a network for transmission of wireless signals with capacity to send digital data, characterized in that there is a at least one first station and at least one second station, the said first station having means to receive and store useful data from a positioning determination source in digital form and being adapted upon an initiation of a close of a transmission to effect transmission of the data to the other station.

In preference, there are means with or within the first station to detect an initiation of the close of a transmission and then effect a maintenance of any transmission status either until further data is transmitted or for a sufficient time to allow for the further data to be transmitted.

The second station may be a dedicated base station, which may be portable, a fixed installation, or vehicle mounted.

In preference, the second station is a base station, adapted to receive the data transmitted by one or more such first stations.

In preference, the second station includes means to recognize the receipt of the data and include means to identify the identity of the source of such data, the location information and the time of transmission and means to transfer such data to a display means.

In a further form of the invention, it may be said to reside in a wireless network including at least two stations, at least one of which is mobile, global positioning means within the mobile station adapted to provide global positioning data of Its position to the mobile station characterized in that the mobile station includes means to initiate transmission from the mobile station to a further station, and there are means upon a detection of initiation of conclusion of a transmission from the mobile station to the other station to cause a transmission of sufficient data from the mobile station to the other station for the global positioning data of the mobile station to be recorded at the other station.

In preference, the data transmission further includes modem synchronizing information transmitted prior to payload data transmission and the payload data itself includes an identification of the source, and global positioning data.

In preference, upon a transmission initiation switch being opened there are means which are adapted to time a delay in closing down of transmission for a sufficient period to allow for the positioning data to then be transmitted.

Such further transmission may include modem synchronizing information prior to data transmission and the data itself may include an identification of the source, global positioning data and, indeed, other data that might be usefully conveyed and which can be electronically established in the first instance.

For instance, such additional data may include wind direction and speed at the particular mobile unit's location, air temperature and humidity.

Such a system may also be useful in the case of emergencies where such additional data may include a distress signal.

In a further embodiment, the invention may reside in a wireless network base station adapted to receive, during termination of a signal being received from a mobile station, data identifying the location of the mobile station.

In a further embodiment, the invention may reside in a method of establishing and monitoring of a location of a mobile wireless transmission station from another location, the method including the steps of effecting transmission of position data from the mobile station upon initiation of termination of a transmission connection with a receiving station.

In another form of the invention, it may be said to reside in a method of monitoring the location of at least one mobile wireless transmission station from another location which includes the steps of initiating a transmit of location data from the mobile wireless transmission station location upon an initiation of a to close transmission switch being effected and where the receiving station is adapted to receive and identify such received data as interpretable data as distinct from any verbal communications.

In a further form of this invention, it can be said to reside in a wireless network base station adapted to receive, during termination of a signal being received from a mobile station, data identifying the location of the mobile station.

Such a station will include means to identify and effect synchronization of a modem, for instance, once recognizing the receipt of such data, be adapted to effect an output of such data in recognizable form for use by others.

Some of the aspects of the invention but it will be better understood if we describe now how this is carried out in practice and, at the same time, other aspects of the invention will be appreciated from this description.

One of the significant advantages of the arrangement thus far described and subsequently described is that in situations where the operator may be required to act quickly or even not be distracted, being able to effect on a reliable and automatic way the position data which also can use conventionally existing transmission channels is of significant advantage.

In trials conducted thus far, it is found that data can be transmitted including synchronization of modems in less than 250 milliseconds in a typical instance.

Further, if there is an over ride timer so that the data is only ever transmitted not more than say every 5 minutes, which period can be determined from time to time depending upon the nature of the situation or the vehicle, this then also aids in reducing crowding on the respective communication channel.

### BRIEF DESCRIPTION OF THE DRAWINGS

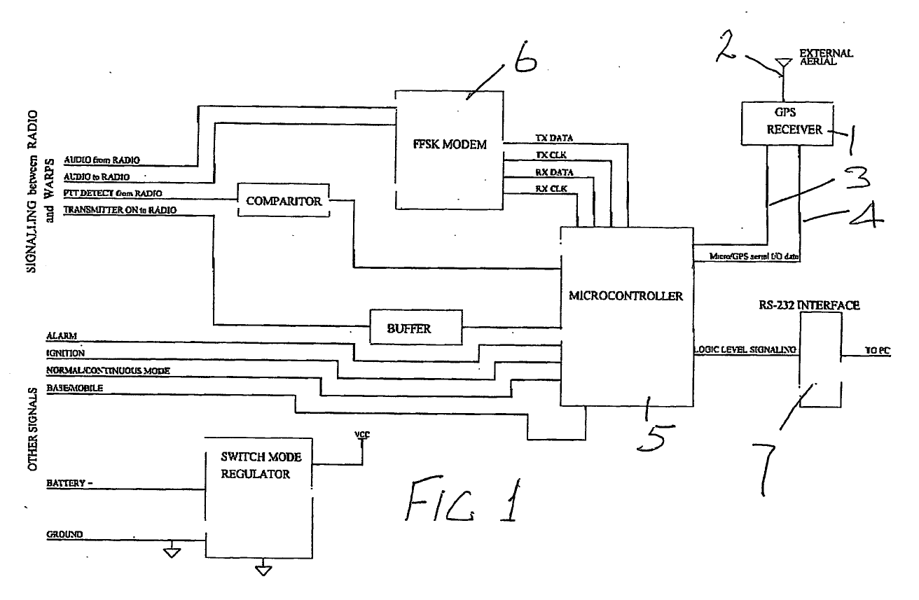

Referring now to a specific embodiment, this is described with the assistance of a drawing wherein FIG. 1 is a schematic layout of operational units relevant to the invention as will be incorporated within a mobile wireless transmission station.

### BEST MODE FOR CARRYING OUT THE INVENTION

Reference will be made to “WARP 1” through the remainder of this document where this, however, shall be an identification of an embodiment incorporating the invention.

A WARP 1 then is an apparatus which is a radio modem with an automatic position determination and transmit capability.

As can be seen in the drawing, it includes a global positioning system receiver 1 which has a conventional receiving aerial 2 and provides data through outputs 3 and 4 to a microcontroller 5.

The microcontroller 5 is arranged to control and effect data manipulation.

A fast frequency shift keyed modem is shown at 6 and there is a processor for signaling and interface circuits for communication with a two way or trunk radio.

It is of interest that there is an output through a connector 7 from the microcontroller to a computer so that the position can also be determined using standard mapping software.

This installation is then mounted on whatever vehicle is appropriate, for instance, whether it is a land or air or sea vehicle and there will be other devices in accordance with this invention located at fixed or mobile base stations elsewhere.

The application is directed toward a two way or trunk radio network.

In the specific instance, the units are configured to operate with a Motorola MCS2000 radio transceiver.

During normal operation, the operator uses the radio to talk to a remote person. At the end of the conversation, the press to talk button on a microphone is released which then acts as a signal initiating the intention of the user to cease transmission.

The logic in the microprocessor is arranged to detect the release of the press to talk button and then promptly seizes control of the radio by forcing the radio transmitter to remain on for a further period whereupon it transmits a data sequence adapted to allow synchronization between the transmit and receive modems and then effects a transmission of a message which is data identifying the transmission source, and location at least as far as it is available from the GPS receiver. Then the radio's transmitter is allowed to switch off.

In this case, such a data transmission is detected and detectable and decodable by a similar unit at a base station or at any other location which is configured to receive this message so that in actual cases, all units on the network may be able to get such position information.

In the embodiment, the sending system's position is displayed on a map on a computer screen together with its identity and status.

The position of other units then may be simultaneously displayed on the same display giving a commander, for instance, a visual display of the disposition of all units.

After the transmission of a message, so that the channel is not unnecessarily crowded, there is effected in this embodiment a timer to inhibit the transmission of any further GPS receiver based data for a modest period of time which can be selected, from time to time, but in this case is 5 minutes.

There is an optional mayday button which initiates transmission and effects a transmission of this synchronizing and data material regardless of the timer status.

Another additional feature includes a continuous transmission switch which enables the continuous transmission of synchronizing and position data at the rate of once per second for a predetermined period.

In this case, this is an override to the conventional improvement of the invention for particular cases where a very short time between data locations could be useful, for instance, when an aircraft is flying along the line of a fire front and it is useful then to determine by the reference to the continuing location of the aircraft, the location of the fire front.

These, however, are exceptions.

Another override facility is the capacity for a base station to activate the transmit capability of any of the mobiles, for instance, by effecting a polling of each of the mobile stations to give their position automatically in return.

Again such a process is useful and is in addition and an exception to the invention.

In polling, there is effected a poll identifying a particular unit so that any retransmitted information is specific to that unit or to a class of units as determined by the transmit signal.

Now for a more detailed description of the operation it is noted as follow.

The microcontroller manages the WARPS which remains normally in its idle state until activated.

The system in a mobile station receives signals from the global position system satellites and calculates its position from these when an adequate number of satellites are communicatable with the position data being updated on a regular basis during access times which information is immediately stored within a memory.

The radio transmitter is activated by an operator when the push to talk button on a microphone is pressed, the microphone is spoken into using conventional verbal audio communication and finally the push to talk button is released normally switching the transceiver from transmit to receive mode.

This, of course, is an initiation to close the transmission mode.

The system detects the release of the press to talk button, forces the transmitter to remain on and transmits a data message consisting of Identity, global position system position and other information over the voice channel.

The initiation of this data transmission includes synchronizing data so that modems at each end can communicate and, in this case, the data message is less than 250 milliseconds long. The transceiver is then allowed to return to receive mode.

In this instance, the apparatus is arranged for data transmission for one minute thereby to reduce congestion on the network. The system may also be interrogated for its position by receiving a data message from the radio. When polled in this way, the system turns the transmitter on, waits a short period to ensure that the link has been established then transmits its data as before.

An override facility is also available which forces transmission once per second so that the vehicle may effectively be tracked in real time.

The most frequent event is the receipt of characters from the GPS engine.

These signals are received as Micro/GPS serial I/O data and are input to a uart in the micro.

Each character from the GPS engine forms part of a message which describes among other things the latitude and longitude of the receiving antennae. Error check characters are appended to the end of the message.

A GPS message is received once per second.

Each GPS character received initiates a change in state of the microcontroller, is saved in a temporary FIFO and the micro returns to the idle state.

When the last error check character is received the message is parsed for correctness and a check of longitudinal parity determined to compare with the received error check characters. If an error is detected the message is discarded and the micro returns to its idle state. If the message is error free the message is saved and flagged ready; the micro returns to the idle state.

The highest priority external interrupt is an event from the comparator indicating that the radio Press-To-Talk button has been released.

The micro enters another state and immediately seizes control of the radio transceiver by forcing the transmitter to remain in the transmit state; this is achieved by holding the TRANSMITTER_ON_to_RADIO signal high or low depending on the type of radio. Various flags are set to drive the finite state machine and the idle state is entered.

An FFSK modem receives analog data from the radio on the AUDIO_from_RADIO line and transmits analog data to the radio on the AUDIO_to_RADIO line.

A digital data clock RX_CLK is derived from the received analog data and this together with the decoded received data RX_DATA is supplied to the microcontroller.

The FFSK modem generates a digital transmit clock TX_CLK and this is used to synchronously strobe digital data TX_DATA from the microcontroller for encoding and transmission.

When WARPS seizes control and has switched the radio transmitter ON the FFSK modem is commanded by the microcontroller to enter another state and to output a data synchronizing sequence for a period, in this case a ONE tone for 25 milliseconds. This is to allow for any anomalous glitches while seizing control and to enable the receiving FFSK modem to determine that an audio carrier is present and to establish bit synchronization. The data message then follows from the microcontroller which modulates the modem for transmission.

Received audio data is converted to digital signals for handling by the micro.

An internal UART in the micro provides signaling to a standard RS-232 interface. The other side of the interface communicates serially with a PC or similar device.

Data from the micro is GPS NMEA data of position etc when WARPS is in mobile mode or is received data from another WARPS if this WARPS is configured as a base station.

Input RS-232 data is only accepted if the WARPS is in base station mode.

This data is an address of another WARPS for polling.

The above describes, in some specific detail, a particular application.

However, it is to be understood that the invention is considered to be applicable to a wide range of applications and Is not to be limited to any specific feature described.

Accordingly, throughout this specification the purpose has been to illustrate the invention and not to limit this.

1. A wireless communication apparatus including voice transmission means characterized in that there is included a location position determination means adapted to output data which uniquely characterizes a geographic location of the apparatus, and means adapted upon an initiation of a close of a voice transmission from said apparatus to effect transmission of data arising from the position determination means whereby such data can effect an identification of the said location which can be interpreted by further receiving means.

2. A wireless communication apparatus as in claim 1 further characterized in that there are means to receive and store said output data from the position determination means in digital form.

3. The wireless communication apparatus of claim 1 further including means to detect an initiation of the close of a transmission status either until the output data is transmitted or for a sufficient time to allow for the output data to be transmitted.

4. The wireless communication apparatus of claim 1 wherein the initiation of the close of a transmission is by release of a transmit button.

5. The wireless communication apparatus of claim 1 means to receive data indicating the geographic location of a further such apparatus.

6. The wireless communication apparatus of claim 5 further including means to recognize the receipt of geographic location data and means to identify the identity of the source of such data, means to interpret the data to provide location information and the time of transmission and means to transfer such information to a display means.

7. The wireless communication apparatus of claim 5 wherein the display means is an electronic means to which data is transferred digitally.

8. The wireless communication apparatus of claim 5 wherein the display means is a manual means to which data is transferred manually.

9. The wireless communication apparatus of claim 1 wherein the data transmission is through frequency shift keying.

10. A network for transmission of wireless signals with capacity to send digital data, characterized in that there is at least one first station and at least one second station, the said first station having means to receive and store useful data from a positioning determination source in digital form and being adapted upon an initiation of a close of a transmission to effect transmission of the data to the other station.

11. The network of claim 10 further including means with or within the first station to detect an initiation of the close of a transmission and then effect a maintenance of any transmission status either until further data is transmitted or for a sufficient time to allow for the further data to be transmitted.

12. The network of claim 10 wherein the second station is a base station, adapted to receive the data transmitted by one or more such first stations.

13. The network of claim 10 wherein the second station includes means to recognize the receipt of the data and include means to identify the identity of the source of such data, the location information and the time of transmission and means to transfer such data to a display means.

14. A wireless network including at least two stations, at least one of which is mobile, global positioning means within the mobile station adapted to provide global positioning data of its position to the mobile station characterized in that the mobile station includes means to initiate transmission from the mobile station to another station, and there are means upon a detection of initiation of conclusion of a transmission from the mobile station to the other station to cause a transmission of sufficient data from the mobile station to the other station for the global positioning data of the mobile station to be recorded at the other station.

15. A wireless network as in claim 10 wherein the data transmission further includes modem synchronizing information transmitted prior to payload data transmission and the payload data itself includes an identification of the source, and global positioning data.

16. A wireless data and audio communication network including at least one base station and at least one mobile station, global positioning system means with or within the mobile station arranged to provide global positioning data of its position to the mobile station in an electronic form characterized in that the mobile station includes a switch means to commence and cease a transmission connection from the mobile station to the base station, and means upon the switch means effecting a commencement of a ceasing of a transmission connection from the mobile station to the base station being detected, adapted to cause a transmission of sufficient data and other signals including data from the global positioning system to the base station for the then position of the mobile station to be transmitted to and be recordable at the base station.

17. A wireless data and audio communication network of claim 16 wherein upon a transmission initiation switch being opened there are means which are adapted to time a delay in closing down of transmission for a sufficient period to allow for the positioning data to then be transmitted.

18. A wireless data and audio communication network of claim 16 wherein the network is further characterized in that an opening of the transmit connect switch to effect a ceasing of transmission effects a data transfer from the mobile station of the positioning data together with a modem set up synchronizing data sequence for the base station.

19. A wireless network base station adapted to receive, during termination of a signal being received from a mobile station, data identifying the location of the mobile station.

20. A method of establishing and monitoring of a location of a mobile wireless transmission station from another location, the method including the steps of effecting transmission of position data from the mobile station upon initiation of termination of a transmission connection with a receiving station.

21. A method of monitoring the location of at least one mobile wireless transmission station from another location which includes the steps of initiating a transmit of location data from the mobile wireless transmission station location upon an initiation of a close transmission switch being effected and where the receiving station is adapted to receive and identify such received data as interpretable data as distinct from any verbal communications.

22. (canceled)

23. The wireless communication apparatus of claim 2 wherein the initiation of the close of a transmission is by release of a transmit button.

24. The wireless communication apparatus of claim 3 wherein the initiation of the close of a transmission is by release of a transmit button.

25. The wireless communication apparatus of claim 2 including means to receive data indicating the geographic location of a further such apparatus.

26. The wireless communication apparatus of claim 3 including means to receive data indicating the geographic location of a further such apparatus.

27. The wireless communication apparatus of claim 4 including means to receive data indicating the geographic location of a further such apparatus.

28. The network of claim 11 wherein the second station is a base station, adapted to receive the data transmitted by one or more such first stations.

29. The network of claim 11 wherein the second station includes means to recognize the receipt of the data and include means to identify the identity of the source of such data, the location information and the time of transmission and means to transfer such data to a display means.

30. The network of claim 12 wherein the second station includes means to recognize the receipt of the data and include means to identify the identity of the source of such data, the location information and the time of transmission and means to transfer such data to a display means.

31. A wireless data and audio communication network of claim 17 wherein the network is further characterized in that an opening of the transmit connect switch to effect a ceasing of transmission effects a data transfer from the mobile station of the positioning data together with a modem set up synchronizing data sequence for the base station.
